(19) United States
(12) Patent Application Publication
(10) Pub. No.: US 2016/0104408 A1
(43) Pub. Date: Apr. 14, 2016

(54) METHOD OF DRIVING DISPLAY PANEL AND DISPLAY APPARATUS PERFORMING THE SAME

(71) Applicant: SAMSUNG DISPLAY CO., LTD., Yongin-City (KR)

(72) Inventors: Gi-Geun KIM, Seoul (KR); Geun-Jeong PARK, Daegu (KR); Nam-Gon CHOI, Yongin-si (KR)

(21) Appl. No.: 14/678,091

(22) Filed: Apr. 3, 2015

(30) Foreign Application Priority Data
Oct. 14, 2014 (KR) 10-2014-0138560

(51) Int. Cl. G09G 3/20

(52) U.S. Cl. CPC G09G 3/2003; G09G 2320/0673

(57) ABSTRACT

A method for driving a display panel includes obtaining a first grayscale histogram based on input image data, generating a gamma curve by selectively changing an initial gamma curve based on at least one of the first grayscale histogram or a predetermined power mode, and generating output image data based on the input image data and the gamma curve. When the gamma curve is different from the initial gamma curve, the method includes changing an operating frequency of the display panel from a first frequency to a second frequency. The second frequency is lower than the first frequency. The operating frequency is changed to display an image frame corresponding to the output image data based on the second frequency.

### CROSS-REFERENCE TO RELATED APPLICATION

Korean Patent Application No. 10-2014-0138560, filed on Oct. 14, 2014, and entitled: “Method of Driving Display Panel and Display Apparatus Performing the Same,” is incorporated by reference herein in its entirety.

### BACKGROUND

1. Field

One or more embodiments described herein relate to a method of driving a display panel and display apparatus for performing a panel driving method.

2. Description of the Related Art

Various methods have been proposed to reduce power consumption of a desktop personal computer, a notebook personal computer, and other types of information technology (IT) products which include a display panel. One method involves changing the operating frequency of the panel under various conditions. For example, when the display panel displays a static image, the display panel may be driven at a relatively low frequency in attempt to reduce power consumption.

However, at least in the case some types of displays (e.g., liquid crystal display), when the panel is driven at a relatively low frequency, flicker (e.g., a flashing effect displeasing to human eyes) and/or other defects may occur which degrade display quality.

### SUMMARY

In accordance with one embodiment, a method for driving a display panel includes obtaining a first grayscale histogram based on input image data; generating a gamma curve by selectively changing an initial gamma curve based on at least one of the first grayscale histogram or a predetermined power mode; generating output image data based on the input image data and the gamma curve; and when the gamma curve is different from the initial gamma curve, changing an operating frequency of the display panel from a first frequency to a second frequency, wherein the second frequency is lower than the first frequency and wherein the operating frequency is changed to display an image frame corresponding to the output image data based on the second frequency.

Generating the gamma curve may include selecting a first gamma lookup table, among a plurality of gamma lookup tables, based on a number of first pixels in the first grayscale histogram, the first pixels having grayscale values in a first range that is between second and third ranges of grayscale values; and mapping the initial gamma curve into the gamma curve based on the first gamma lookup table.

When the number of the first pixels in the first grayscale histogram is greater than a reference number, the gamma curve may be different from the initial gamma curve after mapping, and when the number of the first pixels in the first grayscale histogram is equal to or less than the reference number, the gamma curve may be substantially equal to the initial gamma curve after mapping.

When the gamma curve is different from the initial gamma curve after mapping, a number of second pixels in a second grayscale histogram may be less than the number of the first pixels, the second grayscale histogram may be based on the output image data, and the second pixels may have grayscale values in the first range.

When the gamma curve is different from the initial gamma curve after mapping, a difference between the initial gamma curve and the gamma curve may increase based on a lapse of time. When the gamma curve is different from the initial gamma curve after mapping, and when the operating frequency of the display panel is changed from the first frequency to the second frequency, the second frequency may decrease based on a lapse of time.

Generating the gamma curve may include selecting a first gamma lookup table, among a plurality of gamma lookup tables, based on whether the predetermined power mode is enabled; and mapping the initial gamma curve to the gamma curve based on the first gamma lookup table.

When at least one of a plurality of power mode selection signals corresponding to the predetermined power mode is activated, the gamma curve may be different from the initial gamma curve after mapping, and when all of the plurality of power mode selection signals are deactivated, the gamma curve may be substantially equal to the initial gamma curve after mapping.

The method may include determining the operating frequency of the display panel as the first frequency based on the input image data and the first grayscale histogram. Determining the operating frequency of the display panel may include, when the input image data corresponds to a first type for a first predetermined frequency operation, setting the first frequency to be lower than a reference frequency; and when the input image data corresponds to a second type for a second predetermined frequency operation, setting the first frequency to be higher than the reference frequency.

The method may include, when the gamma curve is substantially equal to the initial gamma curve, maintaining the operating frequency of the display panel as the first frequency to display the image frame corresponding to the output image data on the display panel based on the first frequency.

In accordance with another embodiment, a display apparatus includes a display panel; and a timing controller to control an operation of the display panel, wherein the timing controller includes: an image analyzer to obtain a first grayscale histogram based on the input image data; a gamma compensator to generate a gamma curve by selectively changing an initial gamma curve based on at least one selected from the first grayscale histogram and a predetermined power mode; an image processor to generate output image data based on the input image data and the gamma curve; and an operating frequency selector to change an operating frequency of the display panel from a first frequency to a second frequency lower than the first frequency when the gamma curve is different from the initial gamma curve, wherein, when the gamma curve is different from the initial gamma curve, an image frame corresponding to the output image data is displayed on the display panel based on the second frequency.

The gamma compensator may include a gamma storage area to store the first grayscale histogram; a gamma selector to select a first gamma lookup table among a plurality of gamma lookup tables; and a gamma mapper to map the initial gamma curve into the gamma curve based on the first gamma lookup table.

The gamma compensator may include a histogram analyzer to detect a number of first pixels in the first grayscale histogram, the first pixels having grayscale values in a first range between second and third ranges of grayscale values, wherein the gamma selector is to select the first gamma lookup table based on the number of the first pixels in the first grayscale histogram.

When the number of the first pixels in the first grayscale histogram is greater than a reference number, the gamma curve may be different from the initial gamma curve after mapping, and when the number of the first pixels in the first grayscale histogram is equal to or less than the reference number, the gamma curve may be substantially equal the initial gamma curve after mapping.

When the gamma curve is different from the initial gamma curve after mapping, a number of second pixels in a second grayscale histogram may be less than the number of the first pixels, the second grayscale histogram may be obtained based on the output image data, and the second pixels may have grayscale values in the first range.

The gamma selector may receive a plurality of power mode selection signals corresponding to the low power mode and is to select the first gamma lookup table based on whether the predetermined power mode is enabled. When at least one of the plurality of power mode selection signals is activated, the gamma curve may be different from the initial gamma curve after mapping, and when all of the plurality of power mode selection signals are deactivated, the gamma curve may be substantially equal to the initial gamma curve after mapping.

The operating frequency selector may determine the operating frequency of the display panel as the first frequency based on the input image data and the first grayscale histogram. When the input image data corresponds to a first type for a first predetermined frequency operation, the operating frequency selector may set the first frequency to be lower than a reference frequency, and when the input image data corresponds to a second type for a second predetermined frequency operation, the operating frequency selector may set the first frequency to be higher than the reference frequency.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display apparatus;

FIG. 2 illustrates an embodiment of a timing controller;

FIG. 3 illustrates an embodiment of a gamma compensator;

FIG. 4 illustrates an example of a first gamma curve;

FIGS. 5A to 5D illustrate examples of gamma lookup tables;

FIGS. 6A and 6B illustrate examples of grayscale histograms;

FIG. 7 illustrates illustrate another embodiment of a gamma compensator;

FIG. 8 illustrates an embodiment of a method for driving a display panel;

FIG. 9 illustrates an embodiment for determining an operating frequency;

FIG. 10 illustrates an embodiment for generating a second gamma curve; and

FIG. 11 illustrates another embodiment for generating a second gamma curve.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawings, the dimensions of layers and regions may be exaggerated for clarity of illustration. Like reference numerals refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

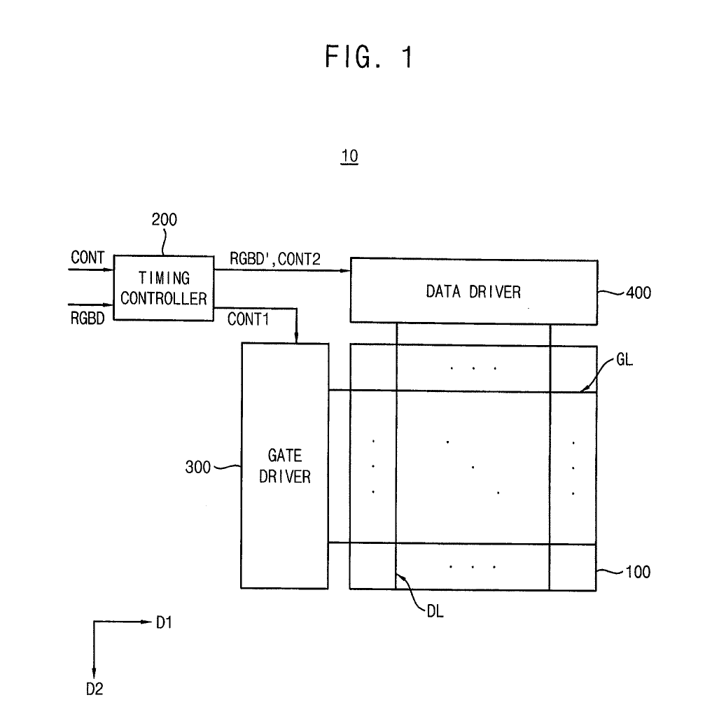

FIG. 1 illustrates an embodiment of a display apparatus 10 which includes a display panel 100, a timing controller 200, a gate driver 300, and a data driver 400. The display panel 100 is connected to a plurality of gate lines GL and a plurality of data lines DL. The display panel 100 displays an image having a plurality of grayscales based on output image data RGBD′. The gate lines GL may extend in a first direction D1, and the data lines DL may extend in a second direction D2 crossing (e.g., substantially perpendicular to) the first direction D1.

The display panel 100 includes a plurality of pixels arranged in a matrix form. Each pixel may be electrically connected to a respective one of the gate lines GL and a respective one of the data lines DL

Each pixel may include a switching element, a liquid crystal capacitor, and a storage capacitor. The liquid crystal capacitor and the storage capacitor may be electrically connected to the switching element. The switching element may be, for example, a thin film transistor. The liquid crystal capacitor may include a first electrode connected to a pixel electrode and a second electrode connected to a common electrode. A data voltage may be applied to the first electrode of the liquid crystal capacitor. A common voltage may be applied to the second electrode of the liquid crystal capacitor.

The storage capacitor may include a first electrode connected to the pixel electrode and a second electrode connected to a storage electrode. The data voltage may be applied to the first electrode of the storage capacitor. A storage voltage may be applied to the second electrode of the storage capacitor. The storage voltage may be substantially equal to the common voltage.

Each pixel may have a predetermined shape, e.g., a rectangular shape. For example, each pixel may have a relatively short side in the first direction D1 and a relatively long side in the second direction D2. The relatively short side may be substantially parallel to the gate lines GL. The relatively long side may be substantially parallel to the data lines DL.

The timing controller 200 controls operation of the display panel 100 and controls operations of the gate driver 300 and the data driver 400. The timing controller 200 receives input image data RGBD and an input control signal CONT, for example, from an external device (e.g., a host). The input image data RGBD may include input pixel data for the plurality of pixels. The input pixel data may include, for example, red grayscale data R, green grayscale data G, and blue grayscale data B for the plurality of pixels. The input control signal CONT may include, for example, a master clock signal, a data enable signal, a vertical synchronization signal, a horizontal synchronization signal, etc. In another embodiment, the input control signal CONT may include a different combination of signals.

The timing controller 200 generates the output image data RGBD′, a first control signal CONT1, and a second control signal CONT2 based on the input image data RGBD and the input control signal CONT. For example, the timing controller 200 may generate the output image data RGBD′ based on the input image data RGBD. The output image data RGBD′ may be provided to the data driver 400. In one embodiment, the output image data RGBD′ may be image data that is substantially the same as the input image data RGBD. In this or another embodiment, the output image data RGBD′ may be compensated image data generated by compensating the input image data RGBD. Similarly to the input image data RGBD, the output image data RGBD′ may include output pixel data for the plurality of pixels.

The timing controller 200 may generate the first control signal CONT1 based on the input control signal CONT. The first control signal CONT1 may be provided to the gate driver 300. A driving timing of the gate driver 300 may be controlled based on the first control signal CONT1. The first control signal CONT1 may include, for example, a vertical start signal, a gate clock signal, etc. The timing controller 200 may generate the second control signal CONT2 based on the input control signal CONT.

The second control signal CONT2 may be provided to the data driver 400. A driving timing of the data driver 400 may be controlled based on the second control signal CONT2. The second control signal CONT2 may include, for example, a horizontal start signal, data clock signal, data load signal, polarity control signal, etc.

The timing controller 200 may also perform the function of determining an operating frequency of the display panel 100. For example, the timing controller 200 may determine the operating frequency of the display panel 100 as a first frequency based on the input image data RGBD, and may perform a gamma remapping operation based on a first grayscale histogram of the input image data RGBD. Based on a result of the gamma remapping operation, the timing controller 200 may generate the output image data RGBD′ by selectively changing the input image data RGBD, and may selectively change the operating frequency of the display panel 100 from the first frequency to a second frequency lower than the first frequency.

The gate driver 300 receives the first control signal CONT1 from the timing controller 200. The gate driver 300 generates a plurality of gate signals for driving the gate lines GL based on the first control signal CONT1. The gate driver 300 may sequentially apply the plurality of gate signals to the gate lines GL.

The data driver 400 receives the second control signal CONT2 and the output image data RGBD′ from the timing controller 200. The data driver 400 generates a plurality of data voltages (e.g., analog data voltages) based on the second control signal CONT2 and the output image data RGBD′ (e.g., digital image data). The data driver 400 may sequentially apply the plurality of data voltages to the data lines DL.

In one embodiment, the data driver 400 may include a shift register, a latch, a signal processor, and a buffer. The shift register may output a latch pulse to the latch. The latch may temporarily store the output image data RGBD′ and may output the output image data RGBD′ to the signal processor. The signal processor may generate the analog data voltages based on the digital output image data RGBD′, the grayscale compensation data GCD, and the gamma reference voltage VGREF, and may output the analog data voltages to the buffer. The buffer may output the analog data voltages to the data lines DL.

In one embodiment, the gate driver 300 and/or the data driver 400 may be disposed (e.g., directly mounted) on the display panel 100, or may be connected to the display panel 100 in, for example, a tape carrier package (“TCP”) type. In another embodiment, the gate driver 300 and/or the data driver 400 may be integrated on the display panel 100.

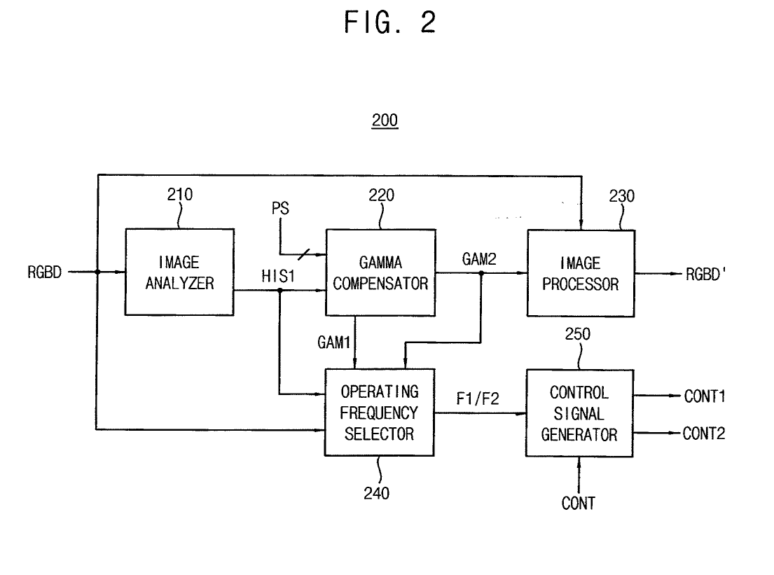

FIG. 2 illustrates an example of a timing controller, which, for example, may correspond to the timing controller 200 in FIG. 1. Referring to FIG. 2, the timing controller 200 includes an image analyzer 210, a gamma compensator 220, an image processor 230, and an operating frequency selector 240. The timing controller 200 may further include a control signal generator 250. The timing controller 200 is illustrated as including five elements; however, the timing controller 200 may not be physically divided and/or may include a different number of elements in another embodiment. The timing controller may be implemented as a controller or processor structure or logic, which, for example, may be implemented in software, hardware, or both.

The image analyzer 210 obtains a first grayscale histogram HIS1 of the input image data RGBD by analyzing the input image data RGBD. The grayscale histogram may represent a relationship between a plurality of grayscales and the number of pixels corresponding to the plurality of grayscales. For example, the input image data RGBD may include the plurality of input pixel data. The first grayscale histogram HIS1 may represent, for example, the number of the input pixel data corresponding to 0˜255 grayscales.

The gamma compensator 220 generates a second gamma curve GAM2 by selectively changing a first gamma curve GAM1 based on at least one of the first grayscale histogram HIS1 or a predetermined power mode. The predetermined power mode may be a reduced power mode or another type of power mode. The first gamma curve GAM1 may be referred to as an initial gamma curve, and the second gamma curve GAM2 may be referred to as a gamma curve. The second gamma curve GAM2 may be different from, or may be substantially the same as, the first gamma curve GAM1.

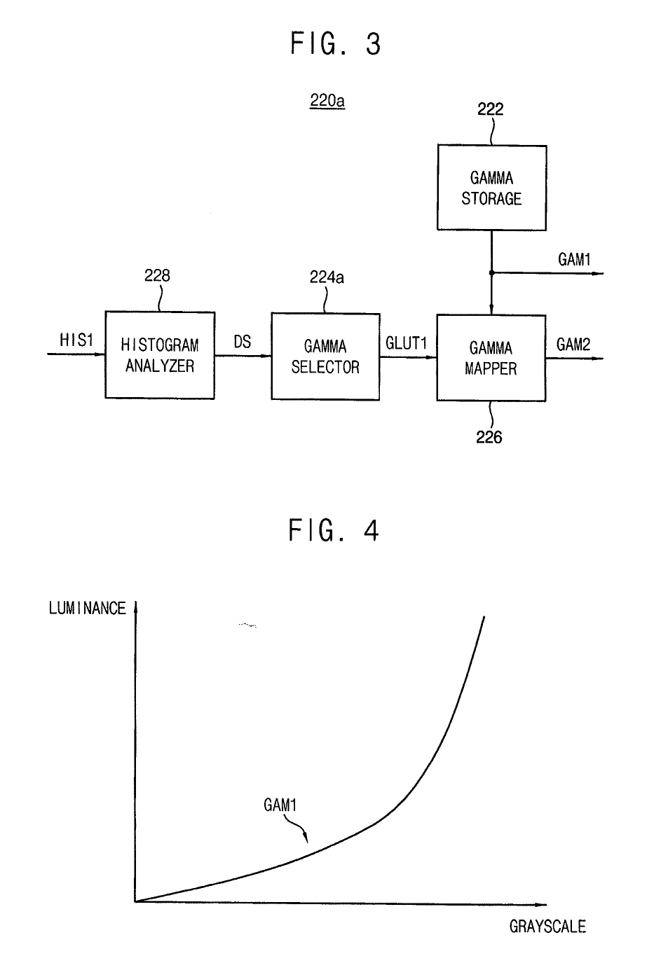

In one embodiment, as will be described with reference to FIG. 3, the gamma compensator 220 may selectively change the first gamma curve GAM1 based on the number of first pixels in the first grayscale histogram HIS1. The first pixels may have middle grayscale values that are higher than a first threshold grayscale value and are lower than a second threshold grayscale value.

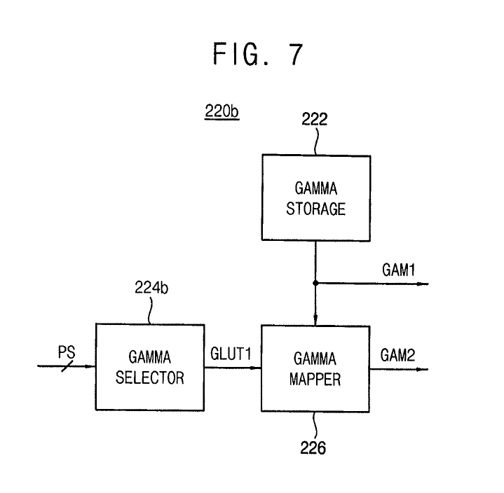

In one embodiment, as will be described with reference to FIG. 7, the gamma compensator 220 may selectively change the first gamma curve GAM1 based on a plurality of power mode selection signals PS corresponding to the low power mode. The plurality of power mode selection signals PS may be received from the external device (e.g., the host).

In another embodiment, the gamma compensator 220 may selectively change the first gamma curve GAM1 based on both the number of the first pixels and the plurality of power mode selection signals PS.

The image processor 230 generates the output image data RGBD′ based on the input image data RGBD and the second gamma curve GAM2. When the second gamma curve GAM2 is substantially the same as the first gamma curve GAM1, the output image data RGBD′ may be substantially the same as the input image data RGBD. When the second gamma curve GAM2 is different from the first gamma curve GAM1, the output image data RGBD′ may be different from the input image data RGBD.

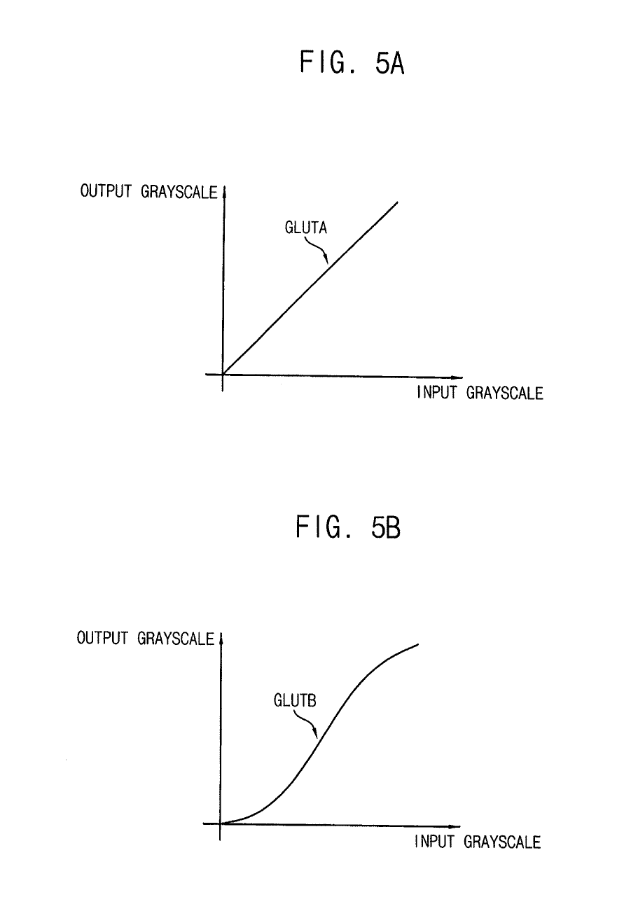

A difference between the second gamma curve GAM2 and the first gamma curve GAM1 and a difference between the output image data RGBD′ and the input image data RGBD will be described below with reference to FIGS. 4, 5A, 5B, 5C, 5D, 6A and 6B.

In one embodiment, the image processor 230 may perform image quality compensation, spot compensation, adaptive color correction (ACC), and/or dynamic capacitance compensation (DCC) for the input image data RGBD in order to generate the output image data RGBD′.

The operating frequency selector 240 determines the operating frequency of the display panel 100 in FIG. 1 based on at least one of the input image data RGBD, the first grayscale histogram HIS1, the first gamma curve GAM1, or the second gamma curve GAM2.

In one embodiment, the operating frequency selector 240 may determine the operating frequency of the display panel 100 in FIG. 1 as a first frequency F1 based on the input image data RGBD and the first grayscale histogram HIS1. When the input image data RGBD corresponds to a first type suitable for a relatively low frequency operation, the operating frequency selector 240 may set the first frequency F1 to be lower than a reference frequency (e.g., about 10 Hz). When the input image data RGBD corresponds to a second type suitable for a relatively high frequency operation, the operating frequency selector 240 may set the first frequency F1 to be higher than the reference frequency (e.g., about 60 Hz). For example, the first type of image may include, for example, a text image or a black-and-white image. The second type of image may include, for example, a natural image or a color image. In another example, the first type of image may include a still image (e.g., static image) and the second type of image may include moving images (e.g., dynamic images).

In one embodiment, the operating frequency selector 240 may change or maintain the operating frequency of the display panel 100 in FIG. 1 based on the first gamma curve GAM1 and the second gamma curve GAM2. When the second gamma curve GAM2 is different from the first gamma curve GAM1, the operating frequency selector 240 may change the operating frequency of the display panel 100 in FIG. 1 from the first frequency F1 to a second frequency F2 lower than the first frequency F1. When the second gamma curve GAM2 is substantially the same as the first gamma curve GAM1, the operating frequency selector 240 may maintain the operating frequency of the display panel 100 in FIG. 1 as the first frequency F1.

The control signal generator 250 may receive the input control signal CONT and may generate the first control signal CONT1 for the gate driver 300 in FIG. 1 and the second control signal CONT2 for the data driver 400 in FIG. 1. These signals may be generated based on the input control signal CONT and the operating frequency of the display panel 100 in FIG. 1, as determined by the operating frequency selector 240. The control signal generator 250 may output the first control signal CONT1 to the gate driver 300 and may output the second control signal CONT2 to the data driver 400.

FIG. 3 illustrates an example of a gamma compensator 220a, which, for example, may correspond to gamma compensator 22 in the timing controller of FIG. 2. Referring to FIG. 3, the gamma compensator 220a includes a gamma storage 222, a gamma selector 224a, and a gamma mapper 226. The gamma compensator 220a may further include a histogram analyzer 228.

The gamma storage 222 may store the first gamma curve GAM1. The first gamma curve GAM1 may be set while the display apparatus 10 in FIG. 1 is manufactured and may be stored in the gamma storage 222. The gamma storage 222 may include, for example, at least one nonvolatile memory such as an electrically erasable programmable read-only memory (EEPROM), a flash memory, a phase change random access memory (PRAM), a resistance random access memory (RRAM), a magnetic random access memory (MRAM), a ferroelectric random access memory (FRAM), a nano floating gate memory (NFGM), or a polymer random access memory (PoRAM).

FIG. 4 illustrating an example of a first gamma curve stored in a gamma storage in FIG. 3. Referring to FIG. 4, the first gamma curve GAM1 may represent a relationship between a grayscale value of pixel data and luminance of an image. Typically, the luminance may increase as the grayscale value increases.

Referring to FIG. 3, the histogram analyzer 228 may detect the number of the first pixels in the first grayscale histogram HIS1 and may generate a detection signal DS corresponding to the number of the first pixels. (As previously described, in one embodiment, the first pixels may have middle grayscale values higher than a first threshold grayscale value and lower than a second threshold grayscale value).

The gamma selector 224a may store a plurality of gamma lookup tables and may select a first gamma lookup table GLUT1 among the plurality of gamma lookup tables. The gamma selector 224a in FIG. 3 may select the first gamma lookup table GLUT1 based on the number of the first pixels in the first grayscale histogram HIS1 (e.g., based on the detection signal DS).

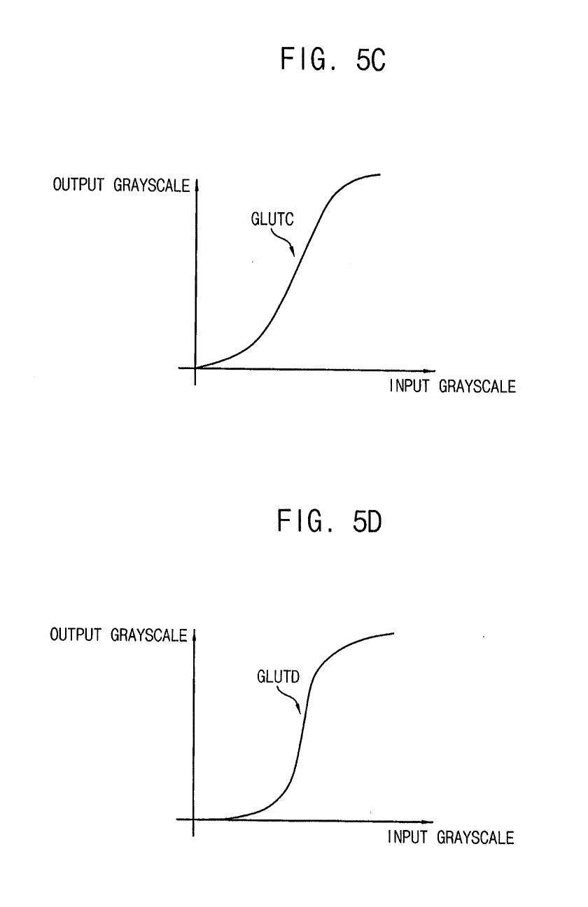

FIGS. 5A, 5B, 5C and 5D illustrate examples of gamma lookup tables stored in a gamma selector in FIG. 3. Referring to FIGS. 5A, 5B, 5C and 5D, each the gamma lookup tables GLUTA, GLUTB, GLUTC and GLUTD may represent a relationship between an input grayscale value and an output grayscale value.

In the gamma lookup table GLUTA of FIG. 5A, an output grayscale value may be substantially the same as an input grayscale value. For example, a transfer function of the gamma lookup table GLUTA of FIG. 5A may be about 1.

In the gamma lookup tables GLUTB, GLUTC, and GLUTD of FIGS. 5B, 5C, and 5D, respectively, an output grayscale value may be different from an input grayscale value. For example, when the input grayscale is a first grayscale in the gamma lookup tables GLUTB, GLUTC, and GLUTD, the output grayscale value may be higher or lower than the first grayscale value. When the input grayscale value has the same value in the gamma lookup tables GLUTB, GLUTC, and GLUTD, a first difference between the input grayscale value and the output grayscale value in the gamma lookup table GLUTB may be less than a second difference between the input grayscale value and the output grayscale value in the gamma lookup table GLUTC, and the second difference may be less than a third difference between the input grayscale value and the output grayscale value in the gamma lookup table GLUTD.

For example, if the input grayscale value is about a 90 grayscale value among 0˜255 grayscale values, the output grayscale value in the gamma lookup table GLUTA of FIG. 5A may be about a 90 grayscale value, the output grayscale value in the gamma lookup table GLUTB of FIG. 5B may be about an 80 grayscale value, the output grayscale value in the gamma lookup table GLUTC of FIG. 5C may be about a 60 grayscale value, and the output grayscale value in the gamma lookup table GLUTD of FIG. 5D may be about a 30 grayscale value. If the input grayscale is about a 165 grayscale value among 0˜255 grayscales, the output grayscale value in the gamma lookup table GLUTA of FIG. 5A may be about a 165 grayscale value, the output grayscale value in the gamma lookup table GLUTB of FIG. 5B may be about a 175 grayscale value, the output grayscale value in the gamma lookup table GLUTC of FIG. 5C may be about a 195 grayscale value, and the output grayscale value in the gamma lookup table GLUTD of FIG. 5D may be about a 225 grayscale value.

Referring back to FIG. 3, when the number of the first pixels in the first grayscale histogram HIS1 is greater than a reference number, the gamma selector 224a may select one of the gamma lookup tables GLUTB, GLUTC and GLUTD of FIGS. 5B, 5C and 5D as the first gamma lookup table GLUT1. When the number of the first pixels in the first grayscale histogram HIS1 is equal to or smaller than the reference number, the gamma selector 224a may select the gamma lookup table GLUTA of FIG. 5A as the first gamma lookup table GLUT1.

The gamma mapper 226 may map the first gamma curve GAM1 to the second gamma curve GAM2 based on the first gamma lookup table GLUT1. For example, the gamma mapper 226 may generate the second gamma curve GAM2 by multiplying the first gamma curve GAM1 and the first gamma lookup table GLUT1. When one of the gamma lookup tables GLUTB, GLUTC, and GLUTD of FIGS. 5B, 5C, and 5D is selected as the first gamma lookup table GLUT1, the second gamma curve GAM2 may be different from the first gamma curve GAM1 after mapping. When the gamma lookup table GLUTA of FIG. 5A is selected as the first gamma lookup table GLUT1, the second gamma curve GAM2 may be substantially the same as the first gamma curve GAM1 after mapping.

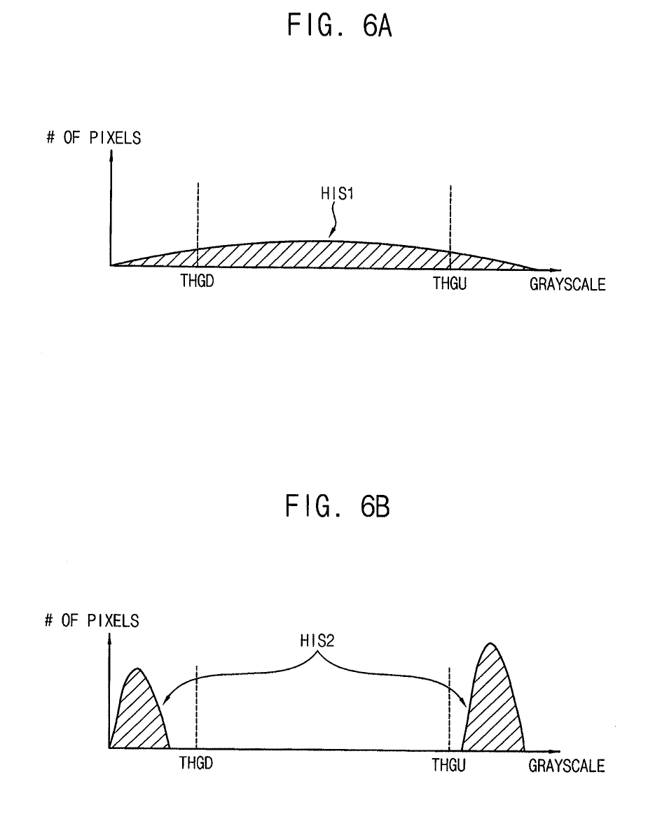

FIGS. 6A and 6B illustrate examples of grayscale histograms obtained from input image data and output image data. Hereinafter, an operation of the display apparatus 10 including the gamma compensator 220a of FIG. 3 will be illustratively described with reference to FIGS. 1, 2, 3, 4, 5A, 5B, 5C, 5D, 6A, and 6B.

The image analyzer 210 may analyze the input image data RGBD to obtain the first grayscale histogram HIS1. For example, the first grayscale histogram HIS1 may be a graph illustrated in FIG. 6A. The operating frequency selector 240 may determine the operating frequency (e.g., an initial operating frequency) of the display panel 100 as the first frequency F1 (e.g., about 30 Hz) based on the input image data RGBD and the first grayscale histogram HIS1.

In the first grayscale histogram HIS1 of FIG. 6A, the number of the first pixels may be relatively large and the number of second pixels may be relatively small. The first pixels may have the middle grayscale values higher than a first threshold grayscale value THGD and lower than a second threshold grayscale value THGU. The second pixels may have low grayscale values equal to or lower than the first threshold grayscale value THGD or may have high grayscale values equal to or higher than the second threshold grayscale value THGU.

As illustrated in FIG. 6A, when the number of the first pixels is relatively large (e.g., when the number of the first pixels in the first grayscale histogram HIS1 is greater than the reference number), the gamma selector 224a may select one of the gamma lookup tables GLUTB, GLUTC, and GLUTD of FIGS. 5B, 5C, and 5D as the first gamma lookup table GLUT1. The gamma mapper 226 may map the first gamma curve GAM1 to the second gamma curve GAM2 based on one of the gamma lookup tables GLUTB, GLUTC, and GLUTD of FIGS. 5B, 5C, and 5D. The image processor 230 may generate the output image data RGBD′ based on the input image data RGBD and the second gamma curve GAM2.

In this case, the second gamma curve GAM2 may be different from the first gamma curve GAM1. When the second gamma curve GAM2 is different from the first gamma curve GAM1 after mapping, the number of third pixels in a second grayscale histogram HIS2 may be less than the number of the first pixels. The third pixels may have the middle grayscale values. The second grayscale histogram HIS2 may be obtained by analyzing the output image data RGBD′. For example, the second grayscale histogram HIS2 may be a graph illustrated in FIG. 6B. The operating frequency selector 240 may change the operating frequency of the display panel 100 from the first frequency F1 to the second frequency F2 (e.g., about 5 Hz), which may be lower than the first frequency F1. An image frame corresponding to the output image data RGBD′ may be displayed on the display panel 100 based on the second frequency F2.

A degree of flicker recognized by a viewer may be different for every image. For example, a first image that includes a relatively large number of pixel data with high grayscale values and/or a relatively large number of pixel data with low grayscale values may be displayed with relatively low flicker. A second image that includes a relatively large number of pixel data with the middle grayscale values may be displayed with relatively high flicker. Thus, the pixel data with the middle grayscale values may be more vulnerable to the flicker. The pixel data with the high grayscale values and the pixel data with the low grayscale values may not be as likely to generate flicker. When the display panel is driven at a relatively low frequency based on an image corresponding, for example, to the grayscale histogram HIS1 in FIG. 6A, flicker may be easily recognized by the viewer.

In one embodiment of the display apparatus 10, the pixel data with the middle grayscale values may be changed to the pixel data with the high grayscale values or the pixel data with the low grayscale values when the input image data RGBD includes a relatively large number of pixel data with the middle grayscale values. For example, the output image data RGBD′ that includes a relatively large number of pixel data with high grayscale values and/or relatively large number of pixel data with low grayscale values may be generated in the display apparatus 10.

The display panel 100 may be driven at a relatively low frequency based on the output image data RGBD′ that includes a relatively large number of pixel data with the high grayscale values and/or relatively large number of pixel data with low grayscale values. Accordingly, flicker on the display panel 100 may be reduced or prevented, and an improved display quality may be achieved.

When the number of the first pixels is relatively small (e.g., when the number of the first pixels in the first grayscale histogram HIS1 is equal to or less than the reference number, and when the first grayscale histogram HIS1 may be similar to the graph illustrated in FIG. 6B), the gamma selector 224a may select the gamma lookup table GLUTA of FIG. 5A as the first gamma lookup table GLUT1. The gamma mapper 226 may map the first gamma curve GAM1 to the second gamma curve GAM2 based on the gamma lookup table GLUTA of FIG. 5A.

The image processor 230 may generate the output image data RGBD′ based on the input image data RGBD and the second gamma curve GAM2. In this case, the second gamma curve GAM2 may be substantially the same as the first gamma curve GAM1 after mapping, and the output image data RGBD′ may be substantially the same as the input image data RGBD. The operating frequency selector 240 may maintain the operating frequency of the display panel 100 as the first frequency F1. An image frame corresponding to the output image data RGBD′ may be displayed on the display panel 100 based on the first frequency F1.

In one embodiment, when the second gamma curve GAM2 is different from the first gamma curve GAM1 after mapping (e.g., when the number of the first pixels in the first grayscale histogram HIS1 is greater than the reference number), a difference between the first gamma curve GAM1 and the second gamma curve GAM2 may gradually increase based on a lapse of time. In this case, the gamma lookup table selected for generating the second gamma curve GAM2 may be sequentially changed by lapse of image frames.

For example, a first image frame may be displayed on the display panel 100 based on the second gamma curve GAM2 generated based on the gamma lookup table GLUTB of FIG. 5B. A second image frame subsequent to the first image frame may be displayed on the display panel 100 based on the second gamma curve GAM2 generated based on the gamma lookup table GLUTC of FIG. 5C. A third image frame subsequent to the second image frame may be displayed on the display panel 100 based on the second gamma curve GAM2 that is generated based on the gamma lookup table GLUTD of FIG. 5D.

In one embodiment, when the second gamma curve GAM2 is different from the first gamma curve GAM1 after mapping (e.g., when the number of the first pixels in the first grayscale histogram HIS1 is greater than the reference number), and when the operating frequency of the display panel 100 is changed from the first frequency F1 to the second frequency F2, the second frequency F2 may gradually decrease based on a lapse of time. In this case, the second frequency F2 may be sequentially changed by lapse of image frames. For example, a first image frame may be displayed on the display panel 100 based on the second frequency F2 of about 20 Hz. A second image frame subsequent to the first image frame may be displayed on the display panel 100 based on the second frequency F2 of about 10 Hz. A third image frame subsequent to the second image frame may be displayed on the display panel 100 based on the second frequency F2 of about 5 Hz.

FIG. 7 illustrates another example of a gamma compensator 220b, which, for example, may be included in the timing controller of FIG. 2. Referring to FIG. 7, the gamma compensator 220b may include a gamma storage 222, a gamma selector 224b and a gamma mapper 226. The gamma storage 222 and the gamma mapper 226 in FIG. 7 may be substantially the same as the gamma storage 222 and the gamma mapper 226 in FIG. 3.

The gamma selector 224b may store a plurality of gamma lookup tables and may select a first gamma lookup table GLUT1 among the plurality of gamma lookup tables. The gamma selector 224b in FIG. 7 may select the first gamma lookup table GLUT1 based on whether the low power mode is enabled (e.g., based on the plurality of power mode selection signals PS corresponding to the low power mode).

When at least one of the plurality of power mode selection signals PS is activated, the gamma selector 224b may select one of the gamma lookup tables GLUTB, GLUTC, or GLUTD of FIGS. 5B, 5C, and 5D as the first gamma lookup table GLUT1. When all of the power mode selection signals PS are deactivated, the gamma selector 224b may select the gamma lookup table GLUTA of FIG. 5A as the first gamma lookup table GLUT1.

Operation of the display apparatus including the gamma compensator 220b of FIG. 7 may be substantially the same as the operation of the display apparatus 10 including the gamma compensator 220a of FIG. 3, except for selection of the first gamma lookup table GLUT1. In one embodiment, the gamma selector in the gamma compensator may select the first gamma lookup table GLUT1, among the plurality of gamma lookup tables, based on both the number of the first pixels and the plurality of power mode selection signals PS.

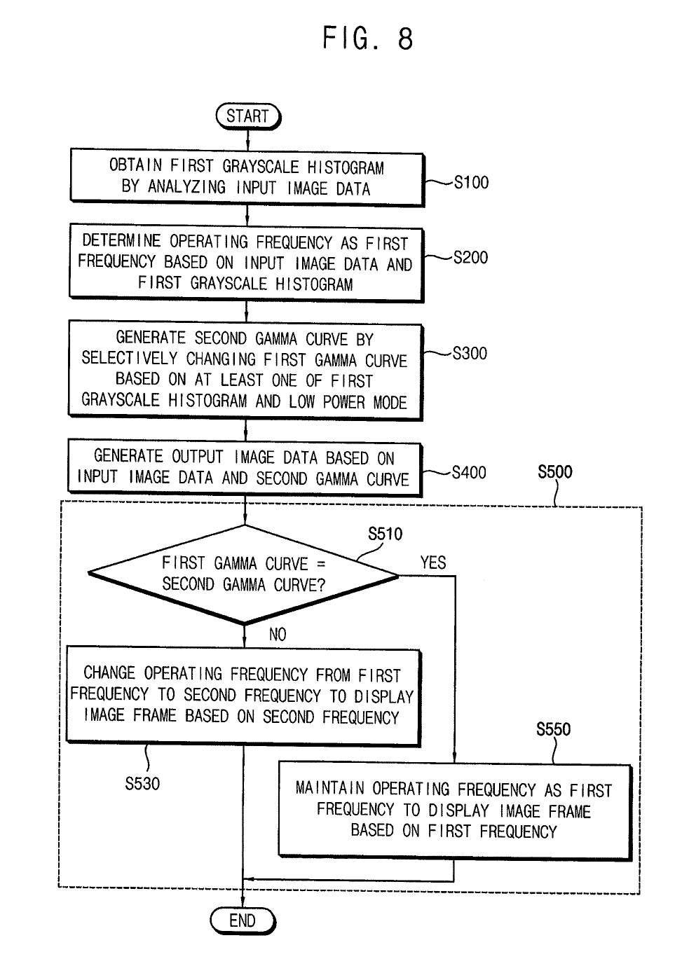

FIG. 8 illustrating an embodiment of a method for driving a display panel, which, for example, may correspond to any of the aforementioned embodiments of the display panel.

Referring to FIGS. 1, 2, and 8, a first grayscale histogram HIS1 of input image data RGBD is obtained by analyzing the input image data RGBD (operation S100). A second gamma curve GAM2 is generated by selectively changing a first gamma curve GAM1 based on at least one selected from the first grayscale histogram HIS1 and a low power mode (operation S300). Output image data RGBD′ is generated based on the input image data RGBD and the second gamma curve GAM2 (operation S400).

An operating frequency of the display panel 100 may be changed or maintained based on the first gamma curve GAM1 and the second gamma curve GAM2 (operation S500). For example, when the second gamma curve GAM2 is different from the first gamma curve GAM1 (operation S510: NO), the operating frequency of the display panel 100 is changed from a first frequency F1 to a second frequency F2 lower than the first frequency F1 to display an image frame corresponding to the output image data RGBD′ on the display panel 100 based on the second frequency F2 (operation S530). When the second gamma curve GAM2 is substantially the same as the first gamma curve GAM1 (operation S510: YES), the operating frequency of the display panel 100 is maintained as the first frequency to display the image frame corresponding to the output image data RGBD′ on the display panel 100 based on the first frequency F1 (operation S550).

In one embodiment, before operation S500, the operating frequency of the display panel 100 may be determined as the first frequency F1 based on the input image data RGBD and the first grayscale histogram HIS1 (operation S200).

In one embodiment, operation S100 may be performed by the image analyzer 210 in the timing controller 200, operations S200 and S500 may be performed by the operating frequency selector 240 in the timing controller 200, operation S300 may be performed by the gamma compensator 220 in the timing controller 200, and operation S400 may be performed by the image processor 230 in the timing controller 200.

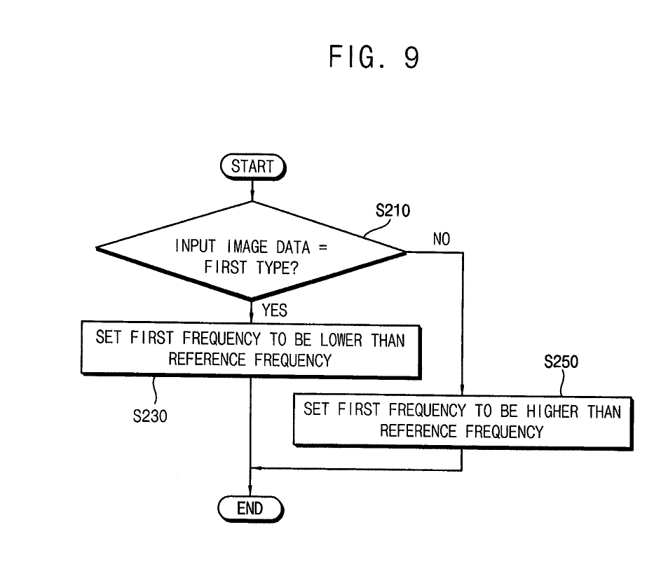

FIG. 9 illustrates an embodiment of a method for determining an operating frequency of the display panel in FIG. 8. Referring to FIGS. 2, 8 and 9, in operation S200, when the input image data RGBD corresponds to a first type suitable for a relatively low frequency operation (operation S210: YES), the first frequency F1 may be set to be lower than a reference frequency (e.g., about 10 Hz) (operation S230). When the input image data RGBD corresponds to a second type suitable for a relatively high frequency operation (operation S210: NO), the first frequency F1 may be set to be higher than the reference frequency (e.g., about 60 Hz) (operation S250).

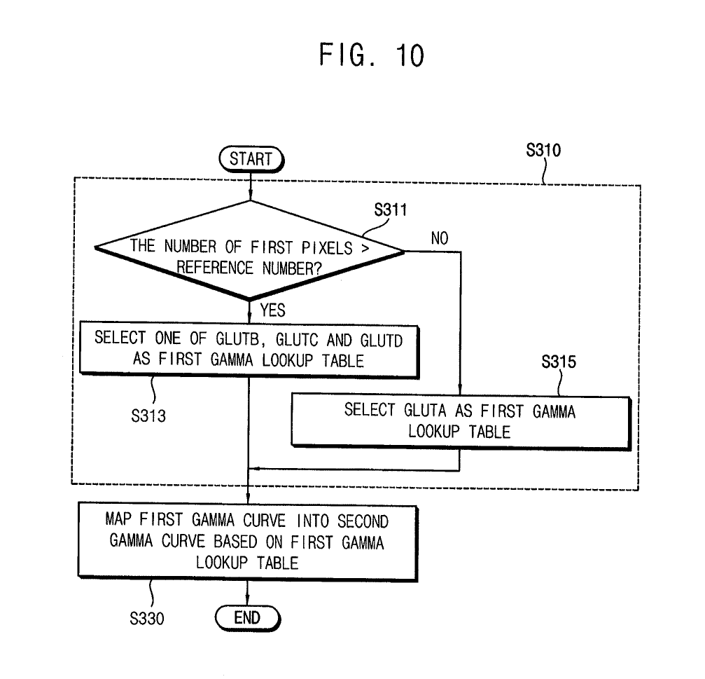

FIG. 10 illustrates an embodiment of a method for generating a second gamma curve in FIG. 8. Referring to FIGS. 3, 8 and 10, in operation S300, a first gamma lookup table GLUT1 may be selected, among a plurality of gamma lookup tables, based on the number of first pixels in the first grayscale histogram HIS1 (operation S310). The first pixels may have middle grayscale values higher than a first threshold grayscale value (e.g., THGD in FIG. 6A) and lower than a second threshold grayscale value (e.g., THGU in FIG. 6A).

For example, when the number of the first pixels in the first grayscale histogram HIS1 is greater than a reference number (operation S311: YES), one of the gamma lookup tables GLUTB, GLUTC, or GLUTD of FIGS. 5B, 5C, and 5D may be selected as the first gamma lookup table GLUT1 (operation S313). When the number of the first pixels in the first grayscale histogram HIS1 is equal to or smaller than the reference number (operation S311: NO), the gamma lookup table GLUTA of FIG. 5A may be selected as the first gamma lookup table GLUT1 (operation S315).

The first gamma curve GAM1 may be mapped into the second gamma curve GAM2 based on the first gamma lookup table GLUT1 (operation S330). For example, when one of the gamma lookup tables GLUTB, GLUTC, or GLUTD of FIGS. 5B, 5C, and 5D is selected as the first gamma lookup table GLUT1, the second gamma curve GAM2 may be different from the first gamma curve GAM1 after mapping. When the gamma lookup table GLUTA of FIG. 5A is selected as the first gamma lookup table GLUT1, the second gamma curve GAM2 may be substantially the same as the first gamma curve GAM1 after mapping.

In one embodiment, operation S310 may be performed by the gamma selector 224a in the gamma compensator 220a, and operation step S330 may be performed by the gamma mapper 226 included in the gamma compensator 220a.

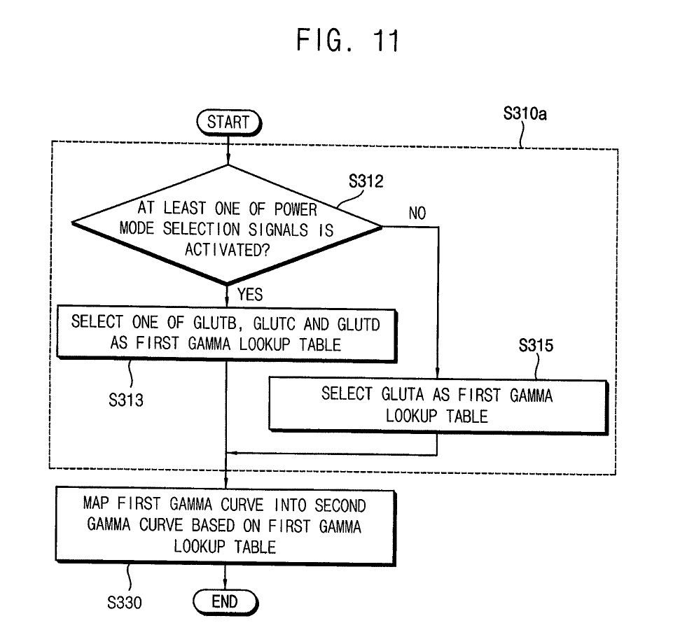

FIG. 11 illustrates another embodiment of a method for generating the second gamma curve in FIG. 8. Referring to FIGS. 7, 8 and 11, in operation S300, the first gamma lookup table GLUT1 may be selected among the plurality of gamma lookup tables based on whether the low power mode is enabled (operation S310a).

For example, when at least one of the plurality of power mode selection signals PS corresponding to the low power mode is activated (operation S312: YES), one of the gamma lookup tables GLUTB, GLUTC, or GLUTD of FIGS. 5B, 5C, and 5D may be selected as the first gamma lookup table GLUT1 (operation S313). When all of the plurality of power mode selection signals PS are deactivated (operation S312: NO), the gamma lookup table GLUTA of FIG. 5A may be selected as the first gamma lookup table GLUT1 (operation S315).

The first gamma curve GAM1 may be mapped to the second gamma curve GAM2 based on the first gamma lookup table GLUT1 (operation S330). Operation S330 in FIG. 11 may be substantially the same as operation S330 in FIG. 10.

In one embodiment, operation S310a may be performed by the gamma selector 224b in the gamma compensator 220b, and operation S330 may be performed by the gamma mapper 226 in the gamma compensator 220b.

In accordance with one embodiment of the method for driving the display panel 100, the output image data RGBD′ may be generated by converting the pixel data with the middle grayscale values to the pixel data with high grayscale values and/or the pixel data with the low grayscale values. For example, the input image data RGBD having the grayscale histogram HIS1 of FIG. 6A may be converted to the output image data RGBD′ having the grayscale histogram HIS2 of FIG. 6B.

The display panel 100 may be driven at a relatively low frequency based on the output image data RGBD′ that includes a relatively large number of pixel data with the high grayscale values and/or the relatively large number of pixel data with the low grayscale values. Accordingly, flicker on the display panel 100 may be reduced or prevented, and the display quality of the display panel 100 may be improved.

The above described embodiments may be used in a display panel, a display apparatus, and/or a system including the display apparatus such as but not limited to a mobile phone, a smart phone, a PDA, a PMP, a digital camera, a digital television, a set-top box, a music player, a portable game console, a navigation device, a personal computer (PC), a server computer, a workstation, a tablet computer, a laptop computer, a smart card, a printer, etc.

By way of summation and review, in at least some types of displays, when a panel is driven at a relatively low frequency, flicker and/or other defects may occur which degrade display quality. In accordance with one or more of the aforementioned embodiments, output image data may be generated by converting pixel data in a predetermined (e.g., middle) range of grayscale values to pixel data in one or more other predetermined ranges, e.g., a range of high grayscale values and/or a range of low grayscale values. The display panel may be driven at a relatively low frequency based on the output image data, where a relatively small number of pixel data being in the range of middle grayscale values that are vulnerable to the flicker. Thus, flicker on the display panel may be reduced or prevented and display quality may be improved.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A method for driving a display panel, the method comprising:
obtaining a first grayscale histogram based on input image data;
generating a gamma curve by selectively changing an initial gamma curve based on at least one of the first grayscale histogram or a predetermined power mode;
generating output image data based on the input image data and the gamma curve; and
when the gamma curve is different from the initial gamma curve, changing an operating frequency of the display panel from a first frequency to a second frequency, wherein the second frequency is lower than the first frequency and wherein the operating frequency is changed to display an image frame corresponding to the output image data based on the second frequency.

2. The method as claimed in claim 1, wherein generating the gamma curve includes:
selecting a first gamma lookup table, among a plurality of gamma lookup tables, based on a number of first pixels in the first grayscale histogram, the first pixels having grayscale values in a first range that is between second and third ranges of grayscale values; and
mapping the initial gamma curve into the gamma curve based on the first gamma lookup table.

3. The method as claimed in claim 2, wherein:
when the number of the first pixels in the first grayscale histogram is greater than a reference number, the gamma curve is different from the initial gamma curve after mapping, and
when the number of the first pixels in the first grayscale histogram is equal to or less than the reference number, the gamma curve is substantially equal to the initial gamma curve after mapping.

4. The method as claimed in claim 3, wherein:
when the gamma curve is different from the initial gamma curve after mapping, a number of second pixels in a second grayscale histogram is less than the number of the first pixels,
the second grayscale histogram is based on the output image data, and
the second pixels have grayscale values in the first range.

5. The method as claimed in claim 3, wherein:
when the gamma curve is different from the initial gamma curve after mapping, a difference between the initial gamma curve and the gamma curve increases based on a lapse of time.

6. The method as claimed in claim 3, wherein:
when the gamma curve is different from the initial gamma curve after mapping, and when the operating frequency of the display panel is changed from the first frequency to the second frequency, the second frequency decreases based on a lapse of time.

7. The method as claimed in claim 1, wherein generating the gamma curve includes:
selecting a first gamma lookup table, among a plurality of gamma lookup tables, based on whether the predetermined power mode is enabled; and
mapping the initial gamma curve to the gamma curve based on the first gamma lookup table.

8. The method as claimed in claim 7, wherein:
when at least one of a plurality of power mode selection signals corresponding to the predetermined power mode is activated, the gamma curve is different from the initial gamma curve after mapping, and
when all of the plurality of power mode selection signals are deactivated, the gamma curve is substantially equal to the initial gamma curve after mapping.

9. The method as claimed in claim 1, further comprising:
determining the operating frequency of the display panel as the first frequency based on the input image data and the first grayscale histogram.

10. The method as claimed in claim 9, wherein determining the operating frequency of the display panel includes:
when the input image data corresponds to a first type for a first predetermined frequency operation, setting the first frequency to be lower than a reference frequency; and
when the input image data corresponds to a second type for a second predetermined frequency operation, setting the first frequency to be higher than the reference frequency.

11. The method as claimed in claim 1, further comprising:
when the gamma curve is substantially equal to the initial gamma curve, maintaining the operating frequency of the display panel as the first frequency to display the image frame corresponding to the output image data on the display panel based on the first frequency.

12. A display apparatus, comprising:
a display panel; and
a timing controller to control an operation of the display panel,
wherein the timing controller includes:
an image analyzer to obtain a first grayscale histogram based on the input image data;
a gamma compensator to generate a gamma curve by selectively changing an initial gamma curve based on at least one selected from the first grayscale histogram and a predetermined power mode;
an image processor to generate output image data based on the input image data and the gamma curve; and
an operating frequency selector to change an operating frequency of the display panel from a first frequency to a second frequency lower than the first frequency when the gamma curve is different from the initial gamma curve, wherein, when the gamma curve is different from the initial gamma curve, an image frame corresponding to the output image data is displayed on the display panel based on the second frequency.

13. The display apparatus as claimed in claim 12, wherein the gamma compensator includes:
a gamma storage area to store the first grayscale histogram;
a gamma selector to select a first gamma lookup table among a plurality of gamma lookup tables; and
a gamma mapper to map the initial gamma curve into the gamma curve based on the first gamma lookup table.

14. The display apparatus as claimed in claim 13, wherein the gamma compensator includes:
a histogram analyzer to detect a number of first pixels in the first grayscale histogram, the first pixels having grayscale values in a first range between second and third ranges of grayscale values, wherein the gamma selector is to select the first gamma lookup table based on the number of the first pixels in the first grayscale histogram.

15. The display apparatus as claimed in claim 14, wherein:
when the number of the first pixels in the first grayscale histogram is greater than a reference number, the gamma curve is different from the initial gamma curve after mapping, and
when the number of the first pixels in the first grayscale histogram is equal to or less than the reference number, the gamma curve is substantially equal the initial gamma curve after mapping.

16. The display apparatus as claimed in claim 15, wherein:
when the gamma curve is different from the initial gamma curve after mapping, a number of second pixels in a second grayscale histogram is less than the number of the first pixels,
the second grayscale histogram is obtained based on the output image data, and
the second pixels have grayscale values in the first range.

17. The display apparatus as claimed in claim 13, wherein the gamma selector is to receive a plurality of power mode selection signals corresponding to the predetermined power mode and is to select the first gamma lookup table based on whether the predetermined power mode is enabled.

18. The display apparatus as claimed in claim 17, wherein:
when at least one of the plurality of power mode selection signals is activated, the gamma curve is different from the initial gamma curve after mapping, and
when all of the plurality of power mode selection signals are deactivated, the gamma curve is substantially equal to the initial gamma curve after mapping.

19. The display apparatus as claimed in claim 12, wherein the operating frequency selector is to determine the operating frequency of the display panel as the first frequency based on the input image data and the first grayscale histogram.

20. The display apparatus as claimed in claim 19, wherein:
when the input image data corresponds to a first type for a first predetermined frequency operation, the operating frequency selector sets the first frequency to be lower than a reference frequency, and
when the input image data corresponds to a second type for a second predetermined frequency operation, the operating frequency selector sets the first frequency to be higher than the reference frequency.
